(19) United States
(12) Patent Application Publication
(10) Pub. No.: US 2012/0094732 A1
(43) Pub. Date: Apr. 19, 2012

(54) GAMING APPARATUS HAVING WIDE SCREEN DISPLAY

(76) Inventor: JOSEPH W. COLE, Las Vegas, NV (US)

(21) Appl. No.: 13/331,869

(22) Filed: Dec. 20, 2011

Related U.S. Application Data
(63) Continuation of application No. 12/932,439, filed on Feb. 24, 2011, now abandoned.
Application No. 12/932,439 is a continuation of application No. 11/879,653, filed on Jul. 17, 2007, now abandoned.
Application No. 11/879,653 is a continuation of application No. 11/182,391, filed on Jul. 15, 2005, now abandoned.
Application No. 11/182,391 is a continuation-in-part of application No. 11/067,402, filed on Feb. 25, 2005, now abandoned.
Application No. 11/067,402 is a continuation of application No. 10/253,151, filed on Sep. 23, 2002, now Pat. No. 6,860,814.
Application No. 10/253,151 is a continuation of application No. 09/517,642, filed on Mar. 3, 2000, now Pat. No. 6,475,087.

(51) Int. Cl. A63F 9/24; A63F 13/08

(52) U.S. Cl. 463/13; 463/31; 463/46; 463/20

(57) ABSTRACT

A gaming apparatus for presenting a wager-type game comprises a housing, a wager accepting device, a controller and a display. The controller is configured to cause wagering game information to be displayed by the display in response to a wager. The display comprises a flat-panel display having a wide screen format.

### RELATED APPLICATION DATA

This application is a continuation of U.S. application Ser. No. 12/932,439, which is a continuation of U.S. application Ser. No. 11/879,653, now abandoned, filed Jul. 17, 2007, which is a continuation of U.S. application Ser. No. 11/182,391, filed Jul. 15, 2005, now abandoned, which is a continuation-in-part of U.S. application Ser. No. 11/067,402, filed Feb. 25, 2005, now abandoned, which is a continuation of U.S. application Ser. No. 10/253,151, filed Sep. 23, 2002, now U.S. Pat. No. 6,860,814, which is a continuation of U.S. application Ser. No. 09/517,642, filed Mar. 3, 2000, now U.S. Pat. No. 6,475,087.

### FIELD OF THE INVENTION

The present invention relates to gaming devices.

### BACKGROUND OF THE INVENTION

A wide variety of devices are known for implementing games of skill and/or chance. There are two very common types of gaming devices. A first type of device is the mechanical type slot machine. These machines comprise a cabinet including one or more mechanical reels and associated controls, such as mechanisms for causing the reels to rotate and stop, coin or other monetary acceptors, and a coin dispenser. In use, a user places a bet, such as with one or more coins. Upon instruction, such as by activation of a “spin” button or handle, the machine effects a spin of the reels. If the event the reels stop in a position displaying a predetermined combination of symbols, the player may be paid winnings based on their bet.

A second type of gaming device is the video gaming device. Such devices comprise a cabinet including a cathode ray tube (CRT) for displaying information. A control in the form of hardware and/or software is provided for playing a game, including displaying information on the CRT. For example, in the game known as video poker, the control causes cards to be displayed on the screen, along with other game play information such as bet information. These cabinets are generally very large and heavy. The CRT is supported on a shelf in a main portion of the cabinet and viewable through a opening in the door.

In order to accommodate the substantial differences between the gaming devices adapted to present these games, these gaming devices are currently manufactured as separate and distinct devices. In other words, a manufacturer custom designs one particular device to be configured as a video gaming device, and custom designs another particular device to be a mechanical reel type device.

There are a number of problems with these gaming devices as currently designed. One problem is that the cost of each individual gaming device is high because it has few features which are common to any other gaming device. The components of each device are unique, generally being designed and manufactured separately. In addition, the assembly of each type of device is then different. The cost of producing numerous different parts and the training and time necessary to assemble the different devices raises the cost of the device.

Another problem with these devices is that they are large and heavy. CRT based video gaming devices are very large because they must accommodate the CRT. A CRT used in a gaming device may be 10-20 inches deep, thus necessitating that the gaming device be at least as deep. In addition, because of heat and an electromagnetic field generated by these CRT's, the cabinet of the gaming device must be sufficiently large to permit adequate ventilation and to permit positioning of other components away from the heat generating CRT.

The size of a gaming device is extremely important. In a gaming establishment, gaming revenue is related to the number of gaming devices which can be arranged into the establishment's floor space. This is especially true of river boat casinos, where space is at an extreme premium. The larger the gaming device, the fewer the number of devices which the establishment can operate. When the number of devices is reduced, so is the revenue associated therewith.

Another problem with these devices is that they are costly to maintain. Because each gaming device is different, unique parts must be obtained in order to repair a particular machine. This either requires extensive training for service personnel regarding the configurations of the many different devices, or requires that the service personnel spend additional time when servicing each machine in order to become familiar with it during a service call.

An improved gaming device is desired.

### SUMMARY OF THE INVENTION

A gaming apparatus and methods of configuring the apparatus are disclosed.

In one or more embodiments, a gaming apparatus is configured to present gaming information, such as information regarding a game of chance. The gaming apparatus includes a flat-panel display having a wide-screen (i.e. greater than standard 4:3 aspect ratio) format.

Another aspect of the invention is a gaming apparatus comprising a cabinet and a door moveable between a first position and a second position. In its first position, the door cooperates with the cabinet to define a generally closed interior space. In its second position, the door permits access to the interior space.

In one embodiment, the gaming apparatus has a base configuration which permits the gaming apparatus to be assembled into, or converted between, either a reel-type gaming machine or a video-type gaming machine. In particular, either a reel mechanism or a video display may be mounted in alignment with an opening in the door. For example, one or more reels or reel mechanisms may be mounted to the cabinet in alignment with the opening in the door, and a reel-screening panel may be mounted to the door, whereby the reels are viewable through the reel-screening glass when the door is in its closed position. Alternatively, a video display may be mounted to the door so that the video display is viewable through the opening.

In accordance with one embodiment of the invention, the display comprises a liquid crystal, plasma or similar relatively flat and thin display. The cabinet may include at least one mount for supporting one or more reels in a position in which they are viewable through the panel connected to the door. The door may include a common mount which may be used to support either the video display or the reel-screening panel.

One or more embodiments of the invention comprise a method of configuring a base configuration of the gaming apparatus to implement or present a particular game. In accordance with the method, the base configuration may be configured to present a reel-type slot game by installing the screening panel to the door and one or more reels to the cabinet for viewing through the panel. In accordance with the method, the base configuration may be configured to present a video type game by connecting the video display to the door. In one or more embodiments, the configuration of the gaming apparatus may be changed to present one game instead of another after first configured to present a specific game.

Another embodiment of the invention is a gaming apparatus or machine having at least one thin-panel video display mounted to the door thereof. The gaming apparatus may be of the type which permits configuration as either a reel-type machine or video machine, but which is configured as a video gaming machine, or may be a gaming apparatus which is particularly configured only as a video type gaming machine.

In one embodiment, at least one thin-panel video display is mounted so as to be viewable through an opening in a door of the gaming apparatus, such as by mounting the video display to a rear of the door. In another embodiment, the video display may other wise be mounted to the door, such as by mounting it to a front of the door. In one configuration, the video display may be mounted over an opening in the door at the front of the door, and is preferably covered by a protective panel. In a preferred embodiment, the at least one video display is mounted over a generally closed portion of a front of the door. Regardless of the mounting configuration, when the video display is mounted to the front of the door, it is preferably located at a recessed area of the door, whereby the video display does not unacceptably protrude outwardly from the door.

One embodiment of the invention comprises a gaming apparatus having a substantially reduced depth dimension. In this embodiment, the gaming apparatus includes a cabinet having a pair of opposing sides and a front and a back. A door is connected to the gaming apparatus, the door movable between a first position in which it extends over at least a portion of the front of the cabinet and cooperates with the cabinet to define a generally enclosed interior, and a second position in which access to the interior is permitted. In a preferred embodiment, the depth of the cabinet from front to back is less that the width of the cabinet from side-to-side.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a gaming device in accordance with a first embodiment of the invention;

FIG. 2 is a perspective view of the gaming device illustrated in FIG. 1 with a door thereof in an open position and certain components thereof illustrated removed from the device;

FIG. 3 is a partially assembled cross-sectional side view of the gaming device illustrated in FIG. 1 with only certain components in an interior thereof illustrated;

FIG. 4 is a perspective view of the gaming device in accordance with a second embodiment of the invention;

FIG. 5 is a perspective view of the gaming device illustrated in FIG. 4 with a door thereof in an open position and certain components thereof illustrated removed from the device;

FIG. 6 is a perspective, partially exploded view of a gaming machine in accordance with another embodiment of the invention; and

FIG. 7 is an assembled view of the gaming machine illustrated in FIG. 6.

### DETAILED DESCRIPTION OF THE INVENTION

The present invention is a gaming apparatus. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

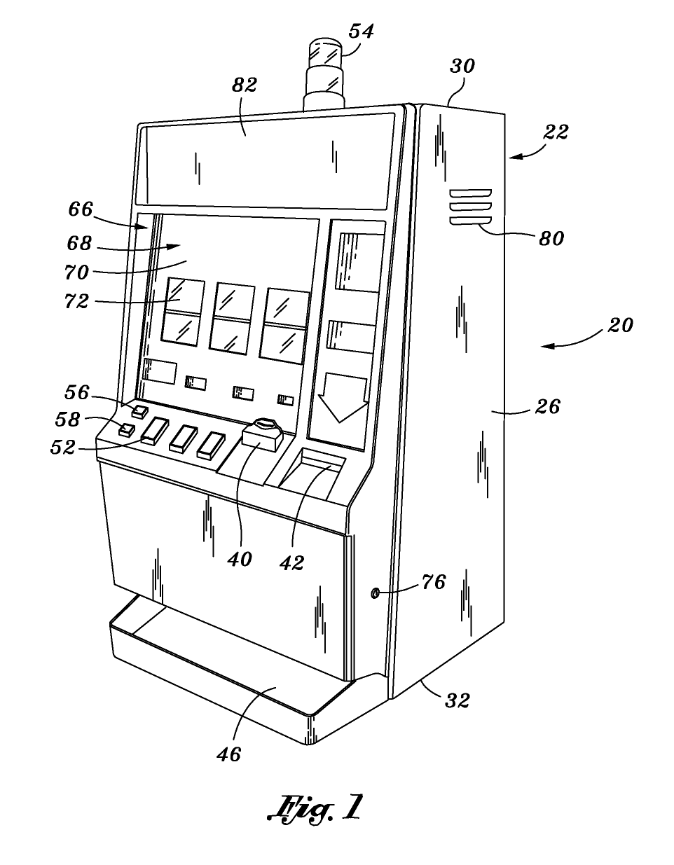

In general, one aspect of the invention comprises a gaming device which is adaptable or configurable into different forms, such as for implementing different types of games. One or more embodiments is a gaming device which may be readily configured either as a “video” type gaming device (FIG. 4) or a mechanical “reel” type gaming device (FIG. 1). Another embodiment of the invention is a gaming device which is compact and consumes minimal space. Another embodiment of the invention is a gaming device which utilizes a door-mounted display. Yet another embodiment of the invention is a gaming device having a wide-screen flat panel video display.

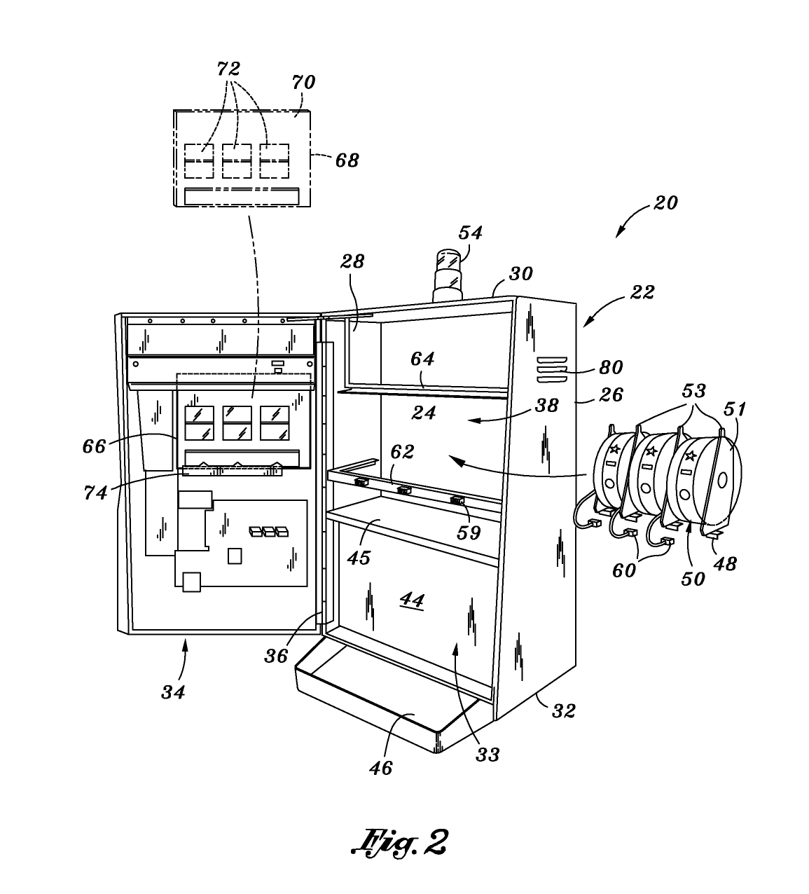

A first embodiment of a gaming device, machine or apparatus 20 in accordance with the present invention will now be described in detail with reference to FIGS. 1-3. The gaming device 20 of the invention includes a housing or cabinet 22. As best illustrated in FIG. 2, the cabinet 22 has a back 24, opposing first and second sides 26,28, a top 30, and a bottom 32. The cabinet 22 may have a wide variety of configurations and shapes and be constructed of a wide variety of materials. For example, the back, sides, top and bottom of the cabinet 22 may be constructed of stamped metal and powder paint coated.

The cabinet 22 has a front 33 which is located opposite the back 24. A front edge of the first and second sides 26, 28, the top 30 and bottom 32 generally define the front 33 of the cabinet 22. As illustrated, the front 33 of the cabinet 22 is generally open.

In one or more embodiments, the distance from the front 33 to the back 24 of the cabinet 22 is less at the top 30 than at the bottom 32. In a preferred embodiment, the depth of the cabinet 22 (i.e. distance from front to back) at the top 30 is in the range of about 12-18 inches or less, while the depth of the cabinet 22 at the bottom 32 (including a coin tray, as disclosed below) is in the range of about 19-26 inches. As illustrated, in a preferred embodiment, the width of the cabinet from side-to-side is greater than the depth of the cabinet, at least in the area of a display (described below).

As will be discussed in more detail below, the cabinet 22 need not have the specific configuration illustrated. It is accordance with the invention, however, it is preferred that the cabinet 22 have a maximum depth of between about 14-18 inches. As will be appreciated, such a depth is much less than that of the standard gaming cabinet, such as in a video gaming device employing a CRT. The reasons such a “thin” cabinet 22 can be provided in accordance with the invention is described in greater detail below.

A door 34 is associated with the cabinet 22 for selectively opening and closing the front 33 of the cabinet 22. Preferably, the door 34 is mounted to the cabinet 22 for movement between a first, open position and a second, closed position. In one or more embodiments, the door 34 is connected to the cabinet 22 with at least one hinge 36. As illustrated in FIG. 2, a single elongate hinge 36 connects the door 34 and the second side 28 of the cabinet 22. Those of skill in the art will appreciate that a variety of means exist for permitting the door 34 to be moved between open and closed positions with respect to the cabinet 22. The door 34 may actually be selectively removable. It will also be appreciated that the door 34 need not be the same size as the front 33 of the cabinet 22. For example, a portion of the front 33 of the cabinet 22 may be enclosed, with the door 34 comprising only a portion of the front 33 thereof.

In its second, closed position, the door 34 cooperates with the cabinet 22 to define a generally enclosed interior portion 38. In its first, open position, the door 34 permits access to the interior portion 38 of the cabinet 22.

The cabinet 22 and door 34 include features which render the device 20 useful for implementing a game. In accordance with the present invention, the cabinet 22 and door 34 are arranged in a “base” configuration or unit which is readily adapted for use in presenting different types of games. In the embodiment illustrated in FIGS. 1-3, the gaming device 20 is configured as a “reel”-type mechanical gaming machine. Such reel or slot-type machines are well known in a variety of specific configurations. As such, much of the details associated with the device 20 as such is common to known slot or reel gaming machines will not be described herein.

In general, the commonly known slot machine has a number of reels with indicia printed thereon. A user of the machine places a wager that when rotated, the reels will stop in such positions that the indicia displayed thereon will comprise a predetermined winning combination. If a predetermined winning combination of indicia is obtained, then the player is paid a payout. As an example, in a common arrangement, a player is declared a winner of the game if the indicia displayed on the reels after they stop rotating all comprise the same indicia.

As illustrated in FIG. 1, means are provided for accepting a wager by a player. In the embodiment illustrated, a coin acceptor 40 and a monetary bill acceptor 42 are provided. The coin acceptor 40 may be associated with a coin hopper (not shown). The gaming device 20 may include other means for accepting value, such as a ticket reader, magnetic stripe or other device for reading cards or other elements or devices.

As illustrated in FIG. 2, a lower part or portion 44 of the interior is divided or partitioned from the remaining interior space by a panel 45. In accordance with an embodiment of the invention, the coin hopper and a variety of other mechanisms (as described below) may be located in the lower portion 44 of the cabinet 22. The bill acceptor 42 may be associated with a bill validator and stacker (not shown) which may be connected to the door 34 or located in the lower portion 44 of the cabinet 22.

In one or more embodiments of the invention, a player may be paid all or a part of awarded winnings in coins. A coin tray 46 is connected to the cabinet 22 and positioned near the bottom or base 32 thereof. The coin hopper may be arranged to dispense coins in to the tray 46 in the event the player is declared a winner of a particular game. As is known, the player may alternatively be paid with credits, printed slips or to a card or central device/account.

Similar to known slot machines, the device 20 of the present invention includes one or more reels 48. As illustrated, three reels 48 are associated with a reel mechanism 50. Such a mechanism 50 includes an open frame 51, mounts for the reels 48 for permitting rotation of the reels 48, and may include mechanisms for causing the reels 48 to rotate and to stop rotating. Each reel 48 has indicia, such as a variety of symbols associated therewith. The frame 51 may have a variety of configurations. As illustrated, the frame 51 generally includes a number of support plates or members. In other embodiments, the frame 51 may have a configuration more like a housing, being generally enclosed on multiple sides.

A master controller (not shown) is provided for controlling the various components of the device 20 and their functions and is specifically adapted to implementing this type of game. The controller may be arranged to receive an input signal from the coin acceptor/hopper and bill acceptor which indicates that a player has placed the required wager. The controller may then be arranged to display information to the player, such as by illuminating a “spin” button 52. When a player presses the “spin” button 52 or engages another game initiating device, the controller is arranged to cause the reels 48 to spin. The reels 48 may be permitted to freely stop, or the controller may be arranged to generate a signal causing each of the reels 48 to stop in a particular position based on a determined random outcome for the game. In the event the outcome of the game comprises a winning event, then the controller may be arranged to cause coins to be dispensed from the hopper to the coin tray 46.

The controller may also control a number of other mechanisms associated with the device 20, as well known in the art. For example, a candle 54 mounted on the top 30 of the cabinet 22 may be arranged to light in one or more instances. For example, the controller may cause the candle 54 to light if the device 20 requires servicing, or if a winning amount to be paid exceeds that which can be paid from the coin hopper to the user.

Referring to FIG. 1, the gaming device 20 may include a number of other buttons or controls. For example, a “cash-out” button 56 may be used to permit a player to obtain coin payment of any credits placed with the device 20. A “play credits” button 58 may be used to permit a player to play the game with credits obtained or already paid.

The controller may comprise a variety of hardware and/or software. In one embodiment, the processor may comprise a circuit board with associated processor(s). In accordance with the present invention, the controller is preferably arranged to be conveniently located under the panel 45. In such an arrangement, the controller is protected from damage from other components, dust and the like. A mount (not shown) may be provided for removably accepting the control unit, such as a circuit board accepting slot. In other embodiments, the controller may be mounted to the panel 45 or may be mounted to the back 24 of the cabinet 22 (for example, some controllers are arranged to be mounted vertically, and others horizontally). The specific mounting arrangement may be dependent upon the configuration of the controller which a gaming company wishes to install.

In accordance with the present invention, the device 20 is uniquely arranged to facilitate the components for implementing the game. First, the cabinet 22 includes at least one mount for mounting of the reel mechanism 50. Preferably, a first or lower support 62 and a second or upper support 64 are connected to the cabinet 22 for mounting of the reel mechanism 50.

The first support 62 comprises a member, such as a bracket, which extends across at least a portion of the interior space 38 of the cabinet 22. As illustrated, the first support 52 extends from the first side 26 to the second side 28 of the cabinet 22. In the embodiment illustrated, the first support 62 is generally “L”-shaped in cross-section, having a planar top and front surface. As shown, the first support 62 is positioned above the panel 45 which serves to define a top of the lower portion 44 of the cabinet 22.

The second support 64 comprises a member, such as a bracket, which also extends across at least a portion of the interior space 38 of the cabinet 22. As illustrated, the second support 64 extends from the first side 26 to the second side 28 of the cabinet 22, generally parallel to the first support 62. The second support 64 is positioned nearer the top 30 of the cabinet 22 than the first support 62. In one or more embodiments, the second support 64 may be generally “U”-shaped, having vertical sections connected to the first and second sides 26,28 of the cabinet 22 and having a generally horizontal section which extends there between through the interior of the cabinet 22.

Means are provided for mounting the reel mechanism 50 to the supports 62,64. In one or more embodiments, the frame 51 of the reel mechanism 50 is connected to the supports 62,64 with fasteners such as bolts, screws, clips or other means known to those of skill in the art. As illustrated, opposing portions of the frame 51 have projections 53 which extend upwardly for insertion into mating slots (not shown) provided in the upper support 64. During installation, the projections 53 may be inserted into the slots, and then the lower portion of the frame 51 secured to the lower support 62, such as with fasteners.

In one or more embodiments, the first support 62 includes one or more connectors 59. The connectors 59 may comprise electrical connectors for engagement with mating connectors 60 associated with the reel mechanism 50. When connected, the connectors 59, 60 provide an electric link from the reel mechanism 50 and the controller.

The first and second supports 62, 64 are positioned such that when the reel mechanism 50 is connected to the cabinet 22, at least a portion of each reel 48 is visible through an opening or window 66 in the door 34.

The window 66 comprises an opening in the door 34 extending there through from a front side (facing away from the cabinet 22 when closed) to a rear or back side (facing the cabinet 22 when closed). The window 66 may have a variety of shapes. As illustrated, the window 66 is slightly elongated in the horizontal direction from square.

In accordance with the present invention, a panel 68 is arranged to be selectively mounted over the opening comprising the window 66. The panel 68 may be constructed of glass, plastic or a number of other materials. Preferably, the panel 68 serves to permit a player of the device 20 to see only one or more portions of the interior portion 38 of the device, thus serving a “screening” function. In one or more embodiments, the panel 68 permits a user to see only a portion of each reel 48 located in the device 22.

As illustrated, this “screening” function is a result of the glass or panel 68 having one or more opaque portions 70, and one or more transparent portions 72. In the embodiment illustrated, there are three transparent portions 72 arranged to align with the three reels 48. Of course, if the device 20 were arranged to have four or more reels, the panel 68 could be arranged to have additional transparent portions. It will also be appreciated that the transparent portion may comprise a single elongate area instead of multiple individual areas.

In one or more embodiments, the door 34 is adapted to receive the panel 68. As illustrated, a support 74 is a mounted on the inside of the door 34 below the window 66. Importantly, the support 74 is arranged to support the window glass 68 in a position such that the transparent portions 72 align with that portion of the interior of the cabinet 22 to be viewed, i.e., the reels 48. Other elements may be used in addition to the support 74 for securing the display to the door, as required. In one or more embodiments, the support 74 is connected to a bracket 75. The bracket 75 may be formed as part of the door or be connected thereto. As described below, the bracket 75 is preferably arranged to accept different supports 74.

As configured as illustrated in FIGS. 1-3, the gaming device 20 has a base configuration or unit which is adapted to implement a reel type game. In particular, the base configuration of the device 20 is arranged to accept a reel mechanism 50 having one or more reels 48. In addition, the base configuration or unit is adapted to receive a panel 68 at the window 66 in a position which serves to limit the viewing window of the user to the pertinent portion of each reel.

The gaming device 20 may include a variety of other features and elements. For example, the door 34 may have a lock 76 associated therewith for locking the door into a closed position and preventing access to the interior space 38 of the cabinet 22. One or more vents 80 may be provided in the sides, back or other areas of the cabinet 22 for providing ventilation. A display area 82 may be provided at a top portion of the door 34 above the window 66. The display area 82 may have a panel therein which is backlit with one or more lights from within the cabinet 22, providing an aesthetically pleasing effect.

In use, the gaming device 20 permits play of a reel-type slot game in similar fashion to standard reel-type gaming machine. In one or more embodiments, a player places a bet, such as through the coin or bill acceptors 40, 42. The player is then permitted to initiate the spinning of the reels 48, such as by pressing the spin button 56. The player is paid a winning amount if the reels 48 stop in a position in which they display a predetermined combination of indicia or symbols. The winnings may be paid in coins to the coin tray 48. During game play, the player is permitted to view the spinning reels 48 through the transparent portions 72 of the panel 68. When the reels 48 stop, the player is permitted to view the symbols displayed in order to identify whether they are a winner.

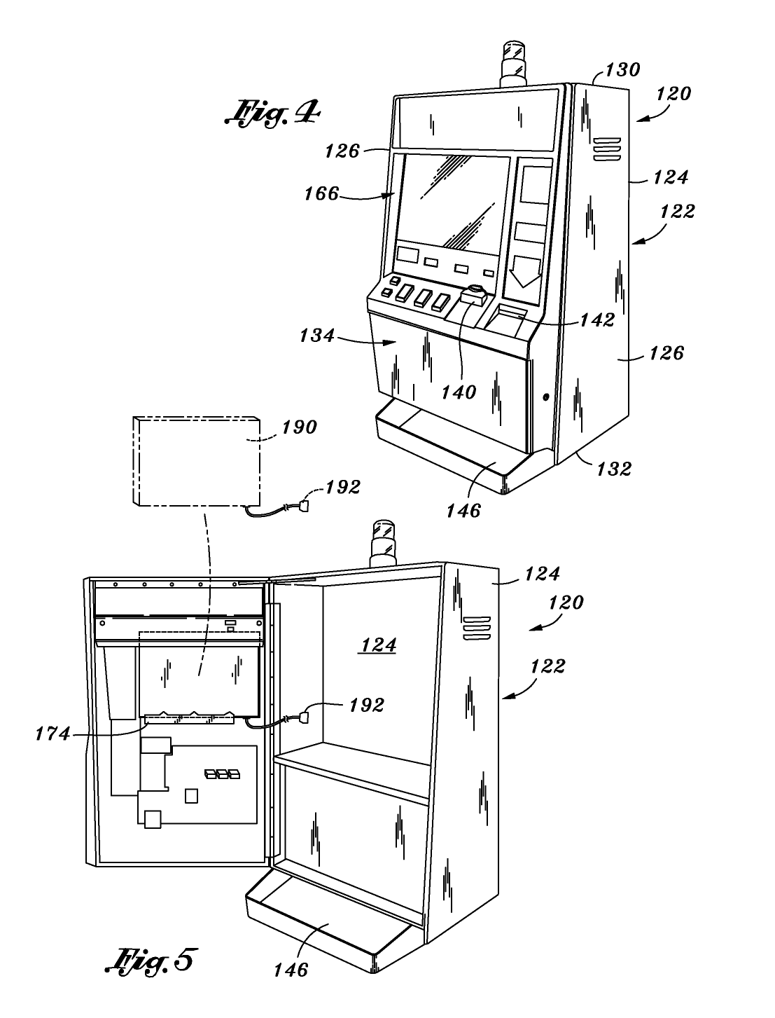

Another embodiment of the invention will now be described with reference to FIGS. 4 and 5. Illustrated therein is a gaming device 120 particularly adapted to presenting a video type game. In one embodiment, the gaming device 120 may be the gaming machine or device 20 illustrated in FIGS. 1-3 and described above, except configured into a video gaming machine. Alternatively, as detailed below, the gaming machine could be specifically configured as illustrated.

In such a configuration, the gaming device 120 shares common features to gaming device 20 described above and configured to present a reel-type gaming device 20. Namely, the device 120 still comprises a cabinet 122 having a back 124, first and second sides 126, 128, a top 130 and a bottom 132. The cabinet 122 preferably has the same shape and dimensions as the cabinet 22 of the previous embodiment. The device 120 still includes the door 134, which is moveable between a first, open position and a second, closed position.

As with the previous device 20, this device 120 may include a number of components for implementing a game, such as a coin acceptor 140, bill acceptor 142, coin tray 146, and a variety of buttons and/or other controls.

In this embodiment, a different or modified controller (not shown) may be used to control the device 120. In particular, a controller is utilized which is adapted to present a different game, such as a video slot or card game, and for displaying associated information on a video screen or display 190. In other words, the video screen or display 190 is preferably used to display the primary game data to the player.

In a preferred embodiment, the display 190 comprises a liquid crystal display (LCD) screen or other substantially planar or thin display. Other types of relatively thin electronic displays now known or later developed may be utilized. Preferably, the display 190 has a thickness or “depth” (i.e. from the front viewing side to a rearmost portion) which is less than 5 inches, and more preferably less than 3 inches. It is also preferred that the display 190 be lightweight. It will be appreciated that such displays do not include current CRT type displays which have depths on the order of 10-20 inches or more and are very heavy.

The display 190 may have a variety of configurations. As best illustrated in FIG. 5, in one embodiment the display 190 has a “wide screen” format. In particular, as illustrated, the display 190 may have an aspect ratio which is greater than the 1.33 aspect ratio of a standard display 4:3 (wherein the 4:3 ratio reflects the horizontal width of the display relative to the vertical height of the display - as used herein, the term “wide screen” means a display having an aspect ratio of greater than that of a standard 4:3 display, or that greater than 1:33). Such wide screen display formats may include the well known 16:9 or 16:10 formats (having aspect ratios of 1.78 and 1.6, respectively). In a preferred embodiment, as illustrated, the display 190 is mounted so that the longer side of the display 190 extends horizontally.

In one embodiment, the display 190 is mounted to the door 134, such as using a support 174. In a preferred embodiment, the support 174 is the same as the support 174 for the panel 68 in the previous embodiment. Thus, the display 190 is utilized instead, or in replacement of, the reel-screening panel 68 when configuring the base unit of the device to specifically implement a video game.

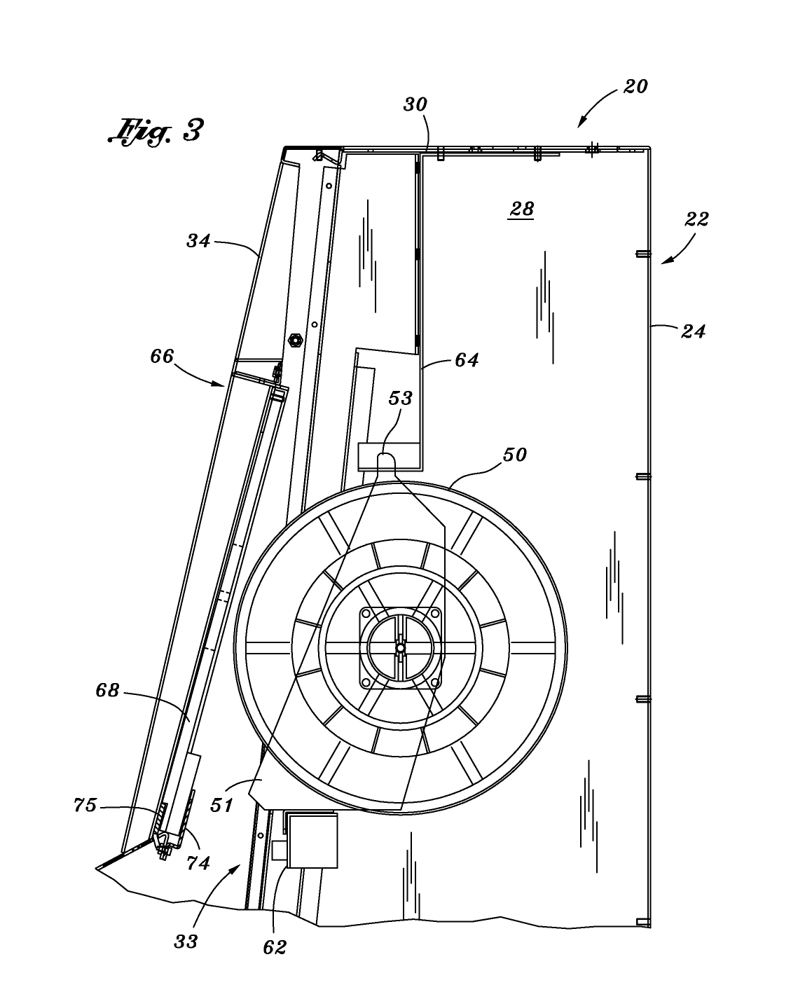

In one or more embodiments, the support 174 utilized to connect the display 190 to the door 134 is different from the support 174 utilized to mount the panel 68, but preferably utilizes common mounts. For example, due to differences in the thickness of the panel 68 and display 190, the support for the screen may be deeper. It is preferred, however, that the supports be interchangeable by selective mounting the different supports to the common bracket 75 (see FIG. 3).

The display 190 is sized to display information for viewing through the window 166 in the door 134. The display 190 includes an interface cable 192 for connection to the controller or similar device. It will be appreciated that a clear panel or glass may be placed over the front surface of the display 190, either as attached to the display 190 or to the door 134 for protecting the display from damage. The panel placed over the display 190 may comprise a touch-screen for accepting touch input from a user. Alternatively, it is noted that the display 190 itself may be arranged to accept touch input.

In this embodiment, the reel mechanism 50 is omitted. As such, the supports 62, 64 present in the previously described embodiment may or may not be omitted, depending on the desire of the user. For example, a builder of the base unit may always wish to include the reel mechanism supports so that, even if the unit is first configured to implement a video game, the device can readily be converted to a reel game. In one or more embodiments, the supports 62, 64 or other supports may be arranged to mount the display 190 in the cabinet for viewing through the window 66.

Use of the device 120 is similar to standard video type gaming devices, depending in part on the specific game which is being implemented. In general, a player is again permitted to place a wager and initiate a game. Data regarding the game is displayed on the display 190. For example, this data may comprise the images of dealt cards for a video poker game, or images of symbols for a video slot game. In the event the player is a winner of the game, the player may be awarded a winning amount.

One aspect of the invention will now be understood to be a gaming machine which has a basic configuration and which can be configured as either a reel-type machine or a video-type machine. As described, in such an embodiment, the basic gaming machine comprises a cabinet with a door, the door preferably configured to accept either a reel-screening panel or a video display, and the cabinet configured to accept one or more mechanical reels. So configured, by either mounting a video display or one or more reels and a reel-screening panel, the gaming machine may be assembled, constructed or modified to have one of two different forms or configurations.

In an alternate configuration, the gaming device 120 may be custom-configured and need not have particularly commonality to the above-described gaming device 20 which may be configured to accept reels or a display. For example, the gaming device 120 may have a wide variety of configurations comprising a housing and a door, with a display mounted to the door (and any mounting configuration of the display to the door may be unique and need not have any utility or cross-use relative to configuring the machine as a reel-type machine).

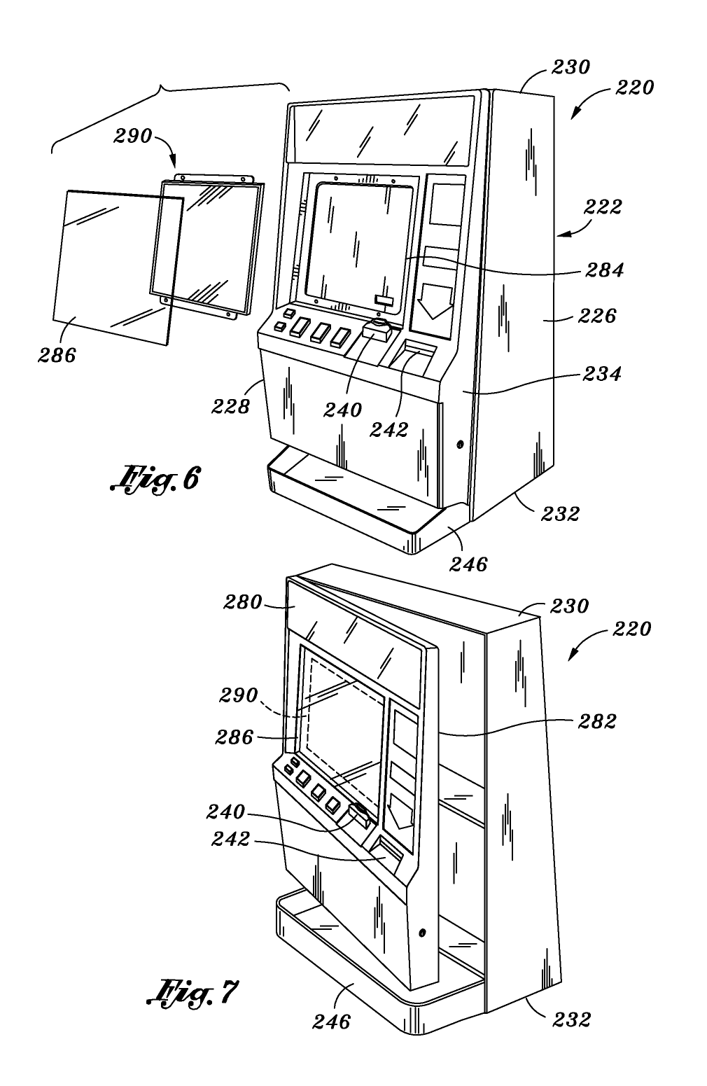

Another embodiment of the invention will now be described with reference to FIGS. 6 and 7. Illustrated therein is a gaming device 220 which includes at least one video display which is preferably utilized to display at least main game data to a player (but which may also display bonus, secondary or other data). The gaming device 220 comprises a video gaming device comprising a cabinet 222 having a back 224, first and second sides 226, 228, a top 230 and a bottom 232. The cabinet 222 may have a wide variety of shapes and configurations, including having a similar same shape and dimensions as the cabinets 22, 122 of the previous embodiments.

A door 234 is moveable between a first, open position and a second, closed position. As with the previous devices 20, 120, this device 220 may include a number of components for implementing a game, such as a coin acceptor 240, bill acceptor 242, coin tray 246, and a variety of buttons and/or other controls. A gaming controller may be used to control the device 220. The controller 220, or one or more components of a control system, may be located within the housing 222. For example, a master gaming controller may be located in the housing 222. In another embodiment, a master or main gaming controller may be located remotely to a number of gaming machines, and each gaming machine may simply include one or more communication devices, a local controller or the like.

In a preferred embodiment, the gaming device 220 includes at least one display for displaying game information. Preferably, the display 290 comprises an electronic thin panel display, such as described above. The display 290 is again preferably mounted to the door 234. As illustrated, the door 234 generally has a front 280 (which faces outwardly towards a user/player) and a back or rear 282 (which faces inwardly towards the cabinet 222). In this embodiment, the display 290 is preferably associated with the front 280 of the door 234, such as by being mounted to the front of the door.

The display 290 can be mounted to the door 234 in various configurations. For example, depending on the desired effect or a theme of the game, the display 290 might be mounted to as to protrude from the gaming machine. In a preferred embodiment, however, the front 280 of the door 234 includes at least one recessed area 284 at which the display 290 is located. The recessed area 284 is configured to accept at least a portion of the display 290 therein so that the display 290 generally has the same elevation/profile as the door and its associated features. For example, the display 290 may be mounted so that a front portion thereof does not extend or protrude outwardly beyond the surrounding portion of the front of the door (i.e. the display 290 is “flush” mounted, at a minimum, or is actually “inset” into the door).

In one embodiment, the display 290 may be mounted over an opening in the door 234. For example, relative to a gaming machine such as that described above including an opening (66, illustrated in FIG. 1), the display 290 could be mounted over the opening, thus closing the opening. A peripheral portion of the display 290 preferably extends over the edge of the opening in this configuration. Alternatively, the display 290 could be mounted to one or more mounts, such as flanges or other connectors, so as to be mounted at the opening. A screening glass or the like could then be mounted over the display 290 and the surrounding portion of the housing to obscure an portions of the opening not covered by the display.

In a most preferred embodiment, however, as illustrated in FIG. 6, the display 290 is mounted over a generally closed front portion of the door 234. In this configuration, the door 234 may be generally closed or solid and thus define a mounting surface for the display 290. In one embodiment, the display 290 may be mounted to a bracket or be configured to include such a bracket or mount (such as frame which is attached to or which is integral with the display) or other means for connecting the display 290 to the door 234.

In a preferred embodiment, a protective panel 286 (such as glass, plastic or the like) may be placed over the front surface of the display 290, either as attached to the display 290 or to the door 234, to protect the display from damage and secure the display 290 (such as to deter unauthorized removal of the display). The panel placed over the display 290 may comprise a touch-screen for accepting touch input from a user. Alternatively, it is noted that the display 290 itself may be arranged to accept touch input. In those instances where it is desired to inset or flush-mount the display 290, the door 234 may preferably be configured so that if a protective panel 286 is used and essentially comprises a “front” of the display, that panel is inset or flush with the surrounding portions of the door (i.e. the recessed area in the door is configured be sufficiently deep to include the dimension of the panel and any space or offset between the panel and the display 290).

As indicated, in a preferred embodiment, the display 290 may be mounted over a generally closed front portion of the gaming machine door. If the gaming machine is already formed with an opening (such as for reels or in the case of a conversion from an old CRT type machine), the opening could be closed with a panel, such as a metal panel connected to the door, and the display could be mounted to or over that panel.

Where the display 290 is mounted over a generally closed portion of a gaming machine door, one or more openings can be provided in the door through which wiring or the like may pass. For example, video cable and electrical cable may be routed from the interior of the gaming machine through the opening(s) in the door to the display 290.

Use of the gaming devices 120, 220 as including one or more video displays is similar to standard video type gaming devices, depending in part on the specific game which is being implemented. In general, a player is again permitted to place a wager and initiate a game. Data regarding the game is displayed on the display 190, 290. For example, this data may comprise the images of dealt cards for a video poker game, or images of symbols for a video slot game. In the event the player is a winner of the game, the player may be awarded a winning amount.

As indicated above, one embodiment of the invention is a gaming device which is capable of being configured simply and easily to present one or more of several different games. In particular, a gaming device is disclosed which includes a base configuration or unit arranged to accept either a mechanical reel device and panel for configuring the device as a mechanical “slot” type machine, or a thin panel video display (such as an LCD display), for configuring the device as a video type gaming machine.

The gaming device has the advantage that a single base unit can be manufactured simply and cost-efficiently, and yet have multiple uses. A game manufacturer may utilize their specific video and/or game controller along with a display, or a reel-type game controller, reel and panel, to implement a specific gaming device utilizing the base unit. In this manner, the cost of producing these types of gaming devices may be reduced. Because of the configuration of the base unit, either no modifications or insubstantial modifications to the structure are necessary to implement either type of game. It will be appreciated that the “base” configuration of the gaming device of the invention, no matter what game is presented, is the same. As arranged, the window placement and arrangement of the cabinet is such that either a display or a panel and reel mechanism combination may be used therewith.

Another advantage of that embodiment gaming device of the invention is that the base unit portion thereof is standardized, and thus simpler and easier to repair. The unitary construction reduces the number of parts and knowledge necessary to repair the device, as compared to the varying types of devices utilized to currently offer slot and video type games.

The gaming device of the invention can also advantageously be reconfigured. For example, a particular casino may first obtain the device configured as a slot type machine. Based on consumer demand, the casino may find it desirable to offer a greater number of video type gaming devices. In such event, the gaming device in accordance with the invention can readily be configured by removing the reels, controller and glass, and replacing them with a thin panel video (for example, LCD) display and appropriate video game control.

Another aspect of the invention is a gaming device with a reduced dimension or size. As detailed above, in one embodiment, the depth of the cabinet may be reduced from 20-30 inches or more for present designs, to 14-18 inches (when considering the same portion of each cabinet being compared—for example, when considering a gaming machine such as that illustrated in FIG. 1 where the depth dimension increases from a top to a bottom thereof, the maximum dimension (at a bottom thereof) of the gaming cabinet/machine may be reduced in the dimensions/percentages noted), a reduction in average depth of 30-40% or more, in accordance with the present invention. As illustrated, this permits the cabinet to have a depth which is less than the width of the cabinet, contrary to the prior art.

Because the gaming device of the invention has such a small size or “footprint,” it occupies much less space than previous gaming machines offering similar games. Thus, the number of gaming devices in accordance with the invention which can be provided in a fixed space is higher than compared to conventional devices. This permits a gaming operator to offer more devices, and thus increase income, as compared to today. Alternatively, this arrangement presents a gaming operator the opportunity to offer the same number of devices with remaining space capable of being used for other purposes.

A disadvantage of current gaming devices which employ CRT displays is that these displays generate substantial heat and a large and strong electromagnetic field. Because of the heat and magnetic field which is generated, the cabinets must be large to permit other components to be located remote from the CRT. Fans and other devices are generally used to improve ventilation in these devices, adding to their energy use and complexity. An advantage of the gaming device having an LCD or similar display is that heat generation is greatly reduced. Thus, the design of the cabinet is not driven by ventilation requirements, but by aesthetics and other factors. Not only can the cabinet be much smaller because of the reduced space occupied by the display, but other components can be located close to the display because it does not generate substantial heat. In addition, the problems with electromagnetic fields are not existent with the LCD and other similar types of displays, permitting other electrical components to be placed close thereto.

LCD and similar displays also have several other advantages over CRT type displays. As will be appreciated, it is common for a video game to display a basic menu or symbols associated with one type of game. Because the menu and symbols are displayed for extended periods of time, these images are “burned in” to the screen. When other images are displayed, a shadow image of the base menu or symbols remains on the screen. This is distracting to the player and makes it difficult for the player to see other displayed information. CRT type displays “refresh” the images by re-displaying them multiple times per second. This refresh can generate a visible flicker which causes strain to the eyes of a viewer. LCD and similar displays avoid these problems.

Another aspect of the present invention is a gaming device or machine having one or more door-mounted displays. Significant advantages are realized by connecting the video display to the door of the gaming device. In particular, because the display is connected to the door, no supports are needed in the cabinet for the display, freeing up substantial space within the cabinet for other components, such as circuitry and the like. Also, when the door is moved to its open position, the display is moved out of the interior of the cabinet, making the interior portion of the cabinet more accessible. The attachment of the display to the door also renders the display more readily accessible for servicing or removal.

As indicated above, in one preferred embodiment, the display is mounted to the front of a closed portion of a door of the gaming device. A particular advantage to this configuration is that the door does not need to be configured to include an opening of a particular size. For example, in order to mount a display at an opening, such as at the rear of an opening in the door, the opening needs to be sized close to the size of the display (if the opening is too small, portions of the display will be obscured and if the opening is too large, special brackets must be used to mounted the display in alignment with the opening and a screening panel may be needed to obscure the space between the panel and the edges of the opening). In the preferred embodiment, the door includes a generally planar, closed mounting area. One or more displays of a variety of sizes may be conveniently mounted within this area without having to modify the design of the door.

Another advantage of that configuration is that the door does not include any large openings which might serve a potential point of access to the interior of the gaming machine, thus reducing the risk of a breach of the security of the machine.

While the gaming device of the present invention has been described specifically as used to implement two different types of games, those of skill in the art will appreciate that there are a variety of other games which may be implemented utilizing the device.

As indicated above, the gaming machine may include one or more door mounted displays. For example, the gaming machine could include two video displays, such as used to present a main game and a bonus game. In such event, the displays could be associated with a common opening in the door, or two openings, or simply be mounted to the generally closed front of the door.

The gaming machines of the invention may also include other features. For example, some gaming machines include “top boxes.” These top boxes are associated with the gaming cabinet, such as by mounted to the top of the cabinet. The top box itself generally comprises an enclosure and may have an access panel thereto. The gaming machine may include other secondary devices such as bonus wheels, player tracking devices and a wide variety of other features and elements which are well known to those of skill in the art.

One aspect of the invention is a gaming machine including a flat panel “wide screen” format display. Preferably, such a display is configured to display game information and has an aspect ratio of greater than 4:3. Such a display configuration may be utilized with or apart from the various other aspects of the invention (such as mounting to the door, etc.)

It will be understood that the above described arrangements of apparatus and the method therefrom are merely illustrative of applications of the principles of this invention and many other embodiments and modifications may be made without departing from the spirit and scope of the invention as defined in the claims.

I claim:

1. A gaming apparatus configured to present one or more wager-based games comprising:
a cabinet, a door connected to said cabinet, said door moveable between a first position and a second position, said door in said first position cooperating with said cabinet to define a generally closed interior space, said door in said second position permitting access to said interior space, said door having a front and a rear;
a wager accepting device;
a generally planar video display having a wide screen format; and
a controller configured to cause game information to be displayed by said video display in response to acceptance of a wager.

2. The gaming apparatus in accordance with claim 1 including a mechanism for awarding winnings for a winning game outcome.

3. The gaming apparatus in accordance with claim 1 wherein said planar video display comprises a LCD display.

4. The gaming apparatus in accordance with claim 1 wherein said controller is configured to cause video poker game information to be displayed, said video poker game information comprising images of one or more cards.

5. The gaming apparatus in accordance with claim 1 wherein said controller is configured to cause video slot information to be displayed, said video slot information comprising images of one or more symbols.

6. The gaming apparatus in accordance with claim 1 wherein said video display has an aspect ratio greater than 4:3.

7. The gaming apparatus in accordance with claim 1 wherein said video display has a length and a width, said length exceeding said width, said video display mounted so that said length extends generally horizontally with respect to said gaming apparatus.

8. The gaming apparatus in accordance with claim 1 wherein said video display is a plasma display.
